(19) United States
(12) Patent Application Publication
(10) Pub. No.: US 2025/0110231 A1
(43) Pub. Date: Apr. 3, 2025

(54) SYSTEM AND METHOD OF MULTI-CARRIER SENSING FOR INTEGRATED SENSING AND COMMUNICATION

(71) Applicant: Samsung Electronics Co., Ltd., Gyeonggi-do (KR)

(72) Inventors: Liang HU, San Diego, CA (US); Philippe Jean Marc Michel SARTORI, Naperville, IL (US)

(21) Appl. No.: 18/900,118

(22) Filed: Sep. 27, 2024

Related U.S. Application Data
(60) Provisional application No. 63/586,455, filed on Sep. 29, 2023.

(51) Int. Cl. G01S 13/76; H04W 24/10

(52) U.S. Cl. CPC G01S 13/765; H04W 24/10

(57) ABSTRACT

Systems and methods are disclosed for multi-carrier sensing. A method performed by a UE includes receiving, from a base station, a first RS in a first frequency of a first frequency range; performing first measurements on the first RS; transmitting, to the base station, a first sensing report based on the first measurements; receiving, from the base station, a second RS in a second frequency range of a second frequency range; performing second measurements on the second RS; and transmitting, to the base station, a second sensing report based on the second measurements.

### CROSS-REFERENCE TO RELATED APPLICATION

This application claims the priority benefit under 35 U.S.C. § 119 (e) of U.S. Provisional Application No. 63/586,455, filed on Sep. 29, 2023, the disclosure of which is incorporated by reference in its entirety as if fully set forth herein.

### TECHNICAL FIELD

The disclosure generally relates to multi-carrier sensing. More particularly, the subject matter disclosed herein relates to improvements to multi-carrier sensing for integrated sensing and communication (ISAC).

### SUMMARY

Wireless sensing technologies such as ISAC aim at acquiring information, e.g., sensing data, about a remote object without physical contact. The sensing data of the object and its surroundings can then be utilized for analysis so that meaningful assistance information about the object and its characteristics can be obtained with high resolution and reliable accuracy.

Additionally, as wireless technologies such as massive multiple-input, multiple-output (MIMO) evolve with more antenna elements and wider bandwidth use in higher frequency bands, e.g., mm-wave bands, they become increasingly more reliant on specific and accurate assistance information, such as distance (e.g., range), angle, instantaneous velocity, and area of objects.

Although radar technology and wireless communication technology have coexisted for some time, most of the interworkings between these technologies to date have been focused on interference management so that the two technologies can independently operate as smoothly as possible without disturbing one another. However, this presents additional costs for infrastructure and inefficiencies in spectrum usage.

In ISAC operations, which are expected to be implemented in 6^{th} generation (6G) wireless systems, sensing and communication operations may share the same frequency band and hardware. For example, IEEE 802.11bf has recently been approved to enhance reliability and efficiency of WLAN sensing. The standard aims to use sensing in order to benefit end user applications, such as home security, entertainment, energy management home elderly care, and assisted living. There has also been an increased amount of attention in the mobile wireless industry to introduce ISAC in beyond 5G standards for applications such as traffic monitoring and safety, presence detection, localization, mapping, etc.

An objective of ISAC is to share the spectrum more efficiently and reuse the existing wireless network infrastructure for sensing. In this context, sensing may refer to “radar-like” functionality, i.e., the ability to detect the presence, movement, and other characteristics of objects under the coverage of the wireless network. However, it can also refer to other types of sensing, such as detection of general characteristics of the environment, the local weather conditions, etc.

A benefit of ISAC, compared to the deployment of a separate network to provide sensing functionality, is that the sensing capability can be introduced on large scale at a relatively low incremental cost by piggybacking on infra-structure that is deployed for communication purposes. More specifically, as massive communication infrastructure already exists and it is foreseen that even more dense deployment will be available in the future generations of wireless communication that will allow for enhanced sensing capabilities, this opens up possibilities for mono-static radar applications, i.e., where transmission of the radar signal and reception of the reflected signal are handled by the same node, and for various multi-static setups where transmission and reception can be handled by different collaborating nodes. Also, if implemented properly, integration of sensing into a communication network may have the benefit of better spectrum utilization as compared to assigning separate spectrum chunks for the two applications.

To reliably and efficiently implement ISAC, it has been proposed to use different frequency ranges (e.g., frequency range 1 (FR1) of less than 7 GHz and frequency range 2 (FR2) of greater than 24.2 GHz) for environment sensing.

However, there are advantages and disadvantages of using different frequency ranges for environment sensing.

For example, in FR1, although relatively fast range and angle detection can be achieved, there is a drawback in its low range and angle resolution, along with potentially significant multipath. Conversely, while FR2 and other millimeter-wave (mmWave) frequencies offer high range resolution due to relatively wider bandwidth and high angle resolution due to multiple antenna elements, a radar reference signal (RRS) in FR2 may suffer from relatively slow range and angle detection due to beam sweeping. Therefore, there is a need for a sensing technique using both the advantages of FR1 and FR2 sensing to provide fast, high-quality sensing.

To overcome these issues, systems and methods are described herein for sensing cross carriers of FR1 and FR2 as a scalable and high accuracy method for integrated sensing and communications.

In particular, an aspect of the disclosure is to provide a sensing technique using the advantages of FR1 and FR2 to provide fast and high-quality sensing.

Another aspect of the disclosure is to provide new signaling for a 2-stage sensing procedure leveraging both FR1 and FR2 frequency bands.

Another aspect of the disclosure is to provide new user equipment (UE) measurement quantities and measurement reports for performing a sensing function in a communication systems.

Another aspect of the disclosure is to provide new configurations of a UE report for sensing on FR1 and FR2 carriers.

The above approaches improve on previous methods because they provide mechanisms in which both FR1 and FR2 carriers may be utilized in a scalable and high accuracy method for ISAC.

In an embodiment, a method performed by a UE includes receiving, from a base station, a first reference signal (RS) in a first frequency of a first frequency range; performing first measurements on the first RS; transmitting, to the base station, a first sensing report based on the first measurements; receiving, from the base station, a second RS in a second frequency range of a second frequency range; performing second measurements on the second RS; and transmitting, to the base station, a second sensing report based on the second measurements

In an embodiment, a UE includes a transceiver; and a processor configured to receive, from a base station, via the transceiver, a first RS in a first frequency of a first frequency range, perform first measurements on the first RS, transmit, to the base station, via the transceiver, a first sensing report based on the first measurements, receive, from the base station, via the transceiver, a second RS in a second frequency range of a second frequency range, perform second measurements on the second RS, and transmit, to the base station, via the transceiver, a second sensing report based on the second measurements.

In an embodiment, a method performed by a base station includes transmitting, to a UE, a first RS in a first frequency of a first frequency range; receiving, from the UE, a first sensing report based on first measurements performed by the UE; determining a coarse location of an object based on the first sensing report; transmitting, to the UE, a second RS in a second frequency range of a second frequency range; receiving, from the UE, a second sensing report based on the second measurements; and determining a fine location of the object based on the second sensing report.

### BRIEF DESCRIPTION OF THE DRAWING

In the following section, the aspects of the subject matter disclosed herein will be described with reference to exemplary embodiments illustrated in the figures, in which:

FIG. 1 illustrates an example of sensing mode categorization, according to an embodiment;

FIG. 2 illustrates an orthogonal frequency-division multiple access (OFDMA)-based sensing frame;

FIG. 3 illustrates an example of a first stage, according to an embodiment;

FIG. 4 illustrates an example of a second stage, according to an embodiment;

FIG. 5 is a signal flow diagram illustrating a method in a first scenario according to an embodiment;

FIG. 6 is a signal flow diagram illustrating a method in a second scenario according to an embodiment;

FIG. 7 is a flowchart illustrating a method performed by a UE according to an embodiment;

FIG. 8 is a flowchart illustrating a method performed by a UE according to an embodiment;

FIG. 9 is a flowchart illustrating a method performed by a base station according to an embodiment;

FIG. 10 is a flowchart illustrating a method performed by a base station according to an embodiment;

FIG. 11 is a block diagram of an electronic device in a network environment, according to an embodiment; and

FIG. 12 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,”“pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As indicated above, a higher efficiency for both sensing services and sensing assisted communications may be provided when wireless sensing and communication are integrated in the same wireless channels or environment.

To initiate ISAC in 5G-Advanced, the use of ISAC is being discussed for various use cases. For example, some the use cases identified include intruder detection function in a smart home, pedestrian/animal intrusion detection on a highway, tourist traffic monitoring, health monitoring with distributed sensing and so forth. The identified sensing key performance indicators (KPIs) may include sensing accuracy, sensing resolution, latency, refreshing rate, etc. As a follow-up, potential ISAC technologies and performance feasibility studies are expected to be performed. It is envisioned that, the 5G-Advanced-based ISAC technologies studied in Rel-19 should mainly rely on a current new radio (NR) architecture, with limited specification modifications.

More specifically, four exemplified use cases, which may benefit from ISAC, are as follows:

### Outdoor Smart Transportation:

Use case 1: Perception of blind spots in road traffic area. The blind spot of a car refers to an area where a line of sight is blocked by obstacles or the car itself and cannot be directly observed by a driver. There may also be many sub-use cases, e.g., relating to heavy vehicles, such a large trucks, whose large blind spots of vision cause them to incur the most traffic accidents.

Use case 2: Perception of road dynamic information. This use case can be classified into traffic road jam detection and traffic safety risk detection. In the former, severe traffic congestion will directly reduce travel efficiency, impact people's lives and limit manufactory production, while indirectly increase air pollution and affect people's health. The latter relates to dangerous driving behaviors induced by, for example, speeding, sharp turning, sudden acceleration, and/or sudden braking. However, currently deployed detection that focuses on the acquisition of road dynamic information mainly relies cameras and speed-measuring radars with a limited deployment scope.

### Indoor Smart Life:

Use case 3: Contactless respiration monitoring. Respiratory diseases suffered by people worldwide every day incur a huge global health burden, particularly for vulnerable infants and young children. This use case has been adopted for study, where a human's sleep situation is monitored with 3^{rd} generation partnership project (3GPP)-based wireless signals.

Use case 4: Gesture recognition. Gesture recognition is more flexible to express meaning from movement and positioning of a human body, such as head, hand, leg, and combinatorial human body parts. In general, there are two types of schemes for gesture recognition: “device-based” and “device-free,” respectively corresponding to “wearable devices” and “non-wearable devices.” Sensors for device-based solutions may include a camera, a depth camera, a glove, and a wristband, while sensors for device-free solution mainly include radar.

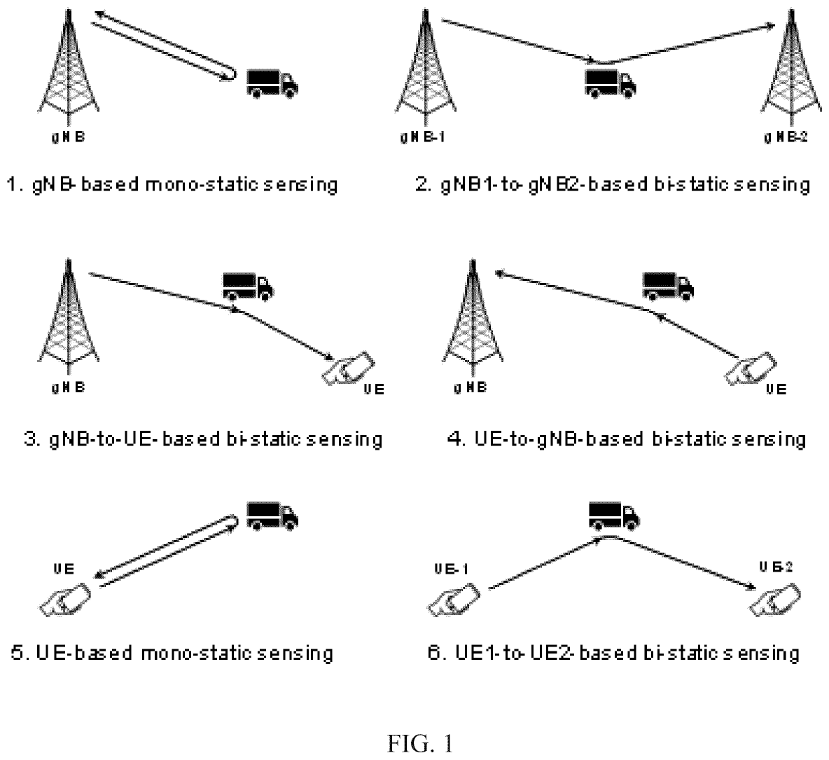

FIG. 1 illustrates an example of sensing mode categorization, according to an embodiment. Although FIG. 1 illustrates six sensing mode categories, the present disclosure is not limited thereto.

Referring to FIG. 1, category 1 represents gNB-based mono-static sensing, category 2 represents gNB1-to-gNB2-based bi-static sensing, category 3 represents gNB-to-UE-based bi-static sensing, category 4 represents UE-to-gNB-based bi-static sensing, category 5 represents UE-based mono-static sensing, and category 6 represents UE1-to-UE2-based bi-static sensing.

For category 1 gNB-based mono-static sensing, a downlink transmission of a gNB is reflected of a target, e.g., a truck, and the reflected signal (or echo) is detected by the gNB.

For category 2 gNB1-to-gNB2-based bi-static sensing, a downlink transmission of a gNB1 is reflected of a target, e.g., a truck, and the reflected signal (or echo) is detected by a gNB1.

For category 3 gNB-to-UE-based bi-static sensing, a downlink transmission of a gNB is reflected of a target, e.g., a truck, and the reflected signal (or echo) is detected by a UE.

For category 4 UE-to-gNB-based bi-static sensing, an uplink transmission of a UE is reflected of a target, e.g., a truck, and the reflected signal (or echo) is detected by a gNB.

For category 5 UE-based mono-static sensing, an uplink transmission of a UE is reflected of a target, e.g., a truck, and the reflected signal (or echo) is detected by the UE.

For category 6 UE1-to-UE2-based bi-static sensing, an uplink transmission of a UE1 is reflected of a target, e.g., a truck, and the reflected signal (or echo) is detected by a UE2.

Additionally, multiple sensing modes can be used together for some use cases. For example, using category 5 UE-based mono-static sensing and category 6 UE1-to-UE2-based bi-static sensing together, an uplink transmission of a UE1 is reflected of a target, e.g., a truck, and the reflected signal (or echo) is detected by the UE1 and a UE2.

### Signal Design for ISAC

In a radar-like scenario, there are requirements on the following:
Range resolution (Rᵣ): a minimum distance between two objects that is distinguishable by a radar.
Unambiguous range (Rᵤ): a maximum range that an object can be unambiguously detected.
Velocity resolution (vᵣ): a minimum change in speed that can be measured by the radar.
Unambiguous velocity (vᵤ): a maximum range of speed (vₘₐₓ−vₘᵢₙ) that can be measured by the radar.

Based on the above required accuracies, there are requirements on a duration, a bandwidth (BW), and a periodicity of a sensing signal.

Table 1 below shows a relationship between sensing signal parameters and sensing requirements.

TABLE 1

| | |
|---|---|
| Minimum bandwidth | BWₘᵢₙ = c/2Rᵣ |
| Minimum gap between sensing signals | T_{r min} = 2Rᵤ/c |
| Maximum gap between sensing signals | T_{r max} = c/4f_{c}vᵤ |
| Minimum sensing frame duration | T_{f min} = c/2f_{c}vᵣ |

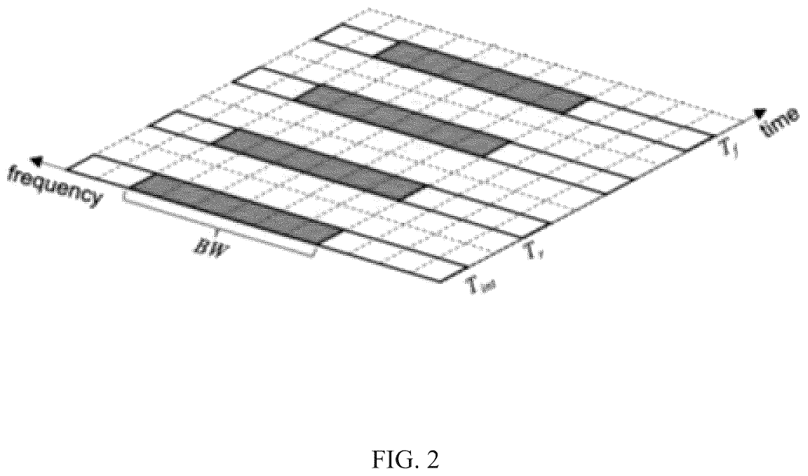

FIG. 2 illustrates an orthogonal frequency-division multiple access (OFDMA)-based sensing frame. Specifically, FIG. 2 illustrates an example of the sensing signal parameters in Table 1.

As described above, there are advantages and disadvantages of using different frequency ranges (e.g., FR1 and FR2) for environment sensing. In FR1, fast range and angle detection can be achieved, but a drawback lies in its low range and angle resolution, along with potentially significant multipath. Conversely, FR2, and other mmWave frequencies, provide high range resolution due to wider bandwidth and high angle resolution thanks to multiple antenna elements. However, an RRS in FR2 may suffer from slow range and angle detection due to beam sweeping. Therefore, there is a need for a sensing technique using the advantages of both FR1 and FR2 sensing to provide fast, high-quality sensing.

Accordingly, an aspect of the present disclosure is to provide sensing cross carriers of FR1 and FR2 as a scalable and high accuracy method for ISAC.

For example, according to an embodiment, new signaling is provided for a 2-stage sensing procedure leveraging both FR1 and FR2 frequency bands. According to another embodiment, new UE measurements quantities and measurement reports are provided for utilizing a sensing function in a communication system.

### 2-Stage Sensing Procedure

The efficiency and accuracy of environment sensing may vary depending on the design and configuration of an RRS. For example, to enhance the performance of sensing, particularly in terms of range, velocity, and angle detection, various parameters of the RRS can be fine-tuned. For instance, increasing the bandwidth of the RRS generally results in a higher range resolution. For velocity detection, a longer time duration of the RRS often provides higher velocity resolution, while increasing the time-domain density often leads to a larger maximum measurable velocity. However, angle detection relies on the number of antenna elements used to transmit the RRS. A higher angle resolution may be attainable by increasing the number of antenna elements. Furthermore, a wider maximum measurable angle can be achieved by reducing the spacing between these antenna elements.

To optimize environment sensing capabilities, an ISAC method is provided using multiple carrier frequencies. In particular, a method includes an anchor carrier (F1) controlling a sensing signal transmitted in a second carrier frequency (F2) for coarse object location detection. Once the coarse detection is complete, the anchor carrier (F1) then manages a sensing signal in a third carrier frequency (F3) for fine detection. The anchor carrier (F1) can operate in FR1. The second carrier frequency (F2) can be from FR1. The third carrier frequency (F3) for fine detection can be FR2. F3 may be close, or not, to either F1 or F2, and in some cases, may be the same as F1 or F2.

The method generally includes two stages.

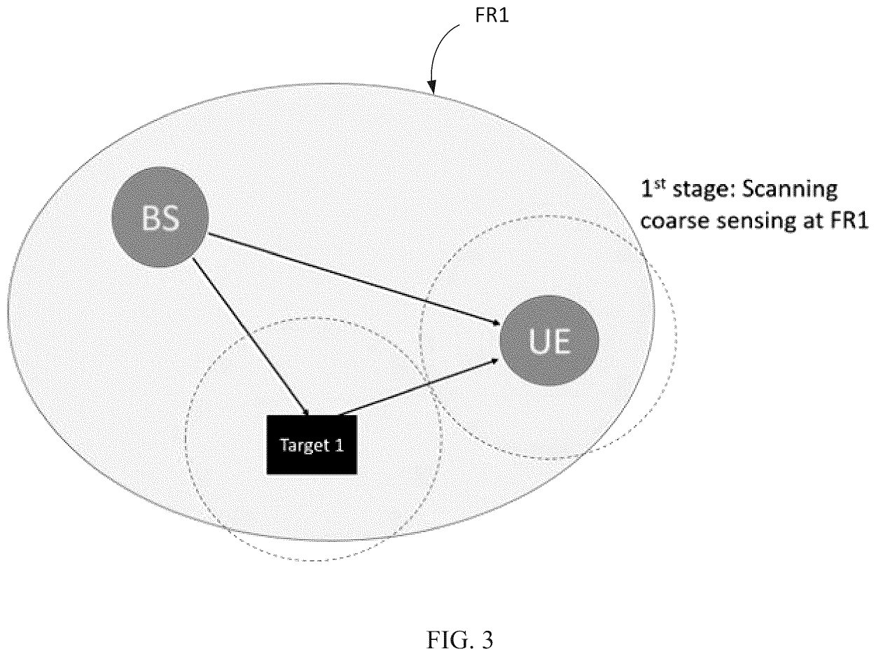

FIG. 3 illustrates an example of a first stage, according to an embodiment.

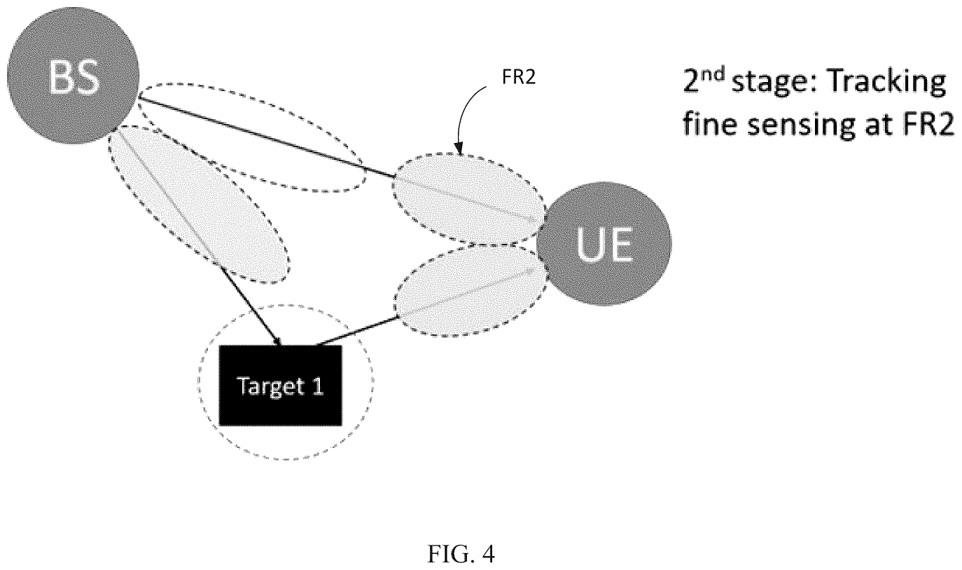

FIG. 4 illustrates an example of a second stage, according to an embodiment.

Referring to FIGS. 3 and 4, the first stage involves coarse detection using F2, and the second stage encompasses fine detection using F3. These stages can be performed sequentially or nearly simultaneously, also known as “one shot” sensing, with some overlap in time. The implementation of multiple carrier frequencies for environment sensing allows for the combination of benefits derived from different frequency ranges. While FR1 provides fast detection, FR2 offers high range and angle resolution. Thus, by the detections from both frequency ranges, a system may achieve enhanced performance with rapid detection and accurate range/angle resolution.

Moreover, the method facilitates flexible scenarios in which either a base station or a UE may transmit sensing signals and/or perform the sensing process based on configuration information received from the anchor carrier (F1). This adaptability allows for fine-tuning an environment sensing process according to specific requirements of a scenario.

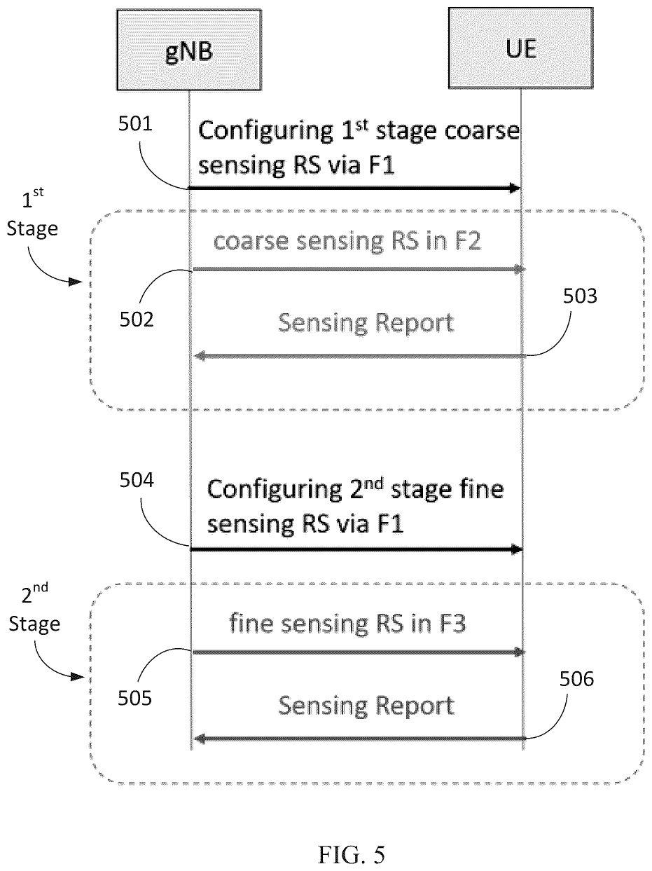

FIG. 5 is a signal flow diagram illustrating a method in a first scenario according to an embodiment.

Referring to FIG. 5, in a first scenario, in step 501, a base station (e.g., a gNB) transmits a sensing signal and performs the sensing.

More specifically, for a 1^{st} stage, i.e., a coarse detection stage, the base station configures a downlink sensing signal to be transmitted in the second carrier frequency (“F2”) and sends the configuration information to the UE, via the anchor carrier frequency (“F1”). The base station may send the configuration information in downlink control information (DCI), MAC control elements (CEs), or radio resource control (RRC) signaling.

In step 502, the base station transmits the downlink sensing signal in the second carrier frequency (F2). Although FIG. 5 illustrates a single sensing signal transmission, multiple transmissions are also possible.

Based on the configuration information received from the base station, the UE receives and measures the downlink sensing signal and, in step 503, reports the measurements to the base station, via a sensing report.

The base station estimates a location of any target objects based on the reported measurement.

For a 2^{nd} stage, i.e., a fine detection stage, in step 504, the base station configures a downlink sensing signal in the third carrier frequency (F3) and transmits it to the candidate region determined in the first stage, via the anchor carrier frequency (F1). The base station may send the configuration information in DCI, MAC CEs, or RRC signaling.

In step 505, the base station transmits the downlink sensing signal in the third carrier frequency (F3) towards the candidate region determined in the 1^{st} stage. Either a single sensing signal transmission or multiple sensing signal transmissions are possible. For example, there may be multiple transmissions in time with different beams (i.e., beam sweeping).

Based on the configuration information received from the base station, the UE receives and measures the downlink sensing signal and, in step 506, reports the measurements to the base station. Based on the received sensing report, the base station may refine the estimated location of any target objects.

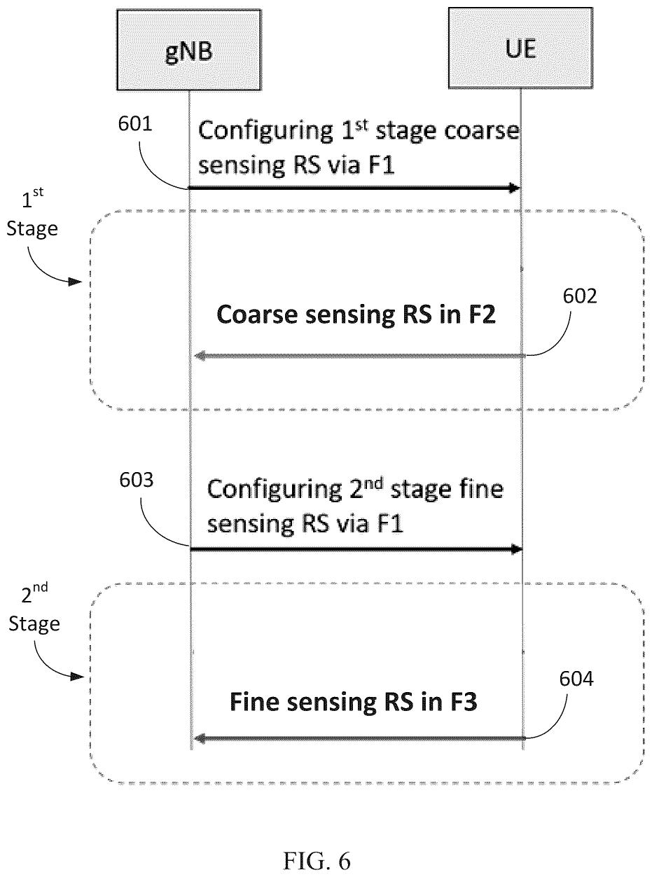

FIG. 6 is a signal flow diagram illustrating a method in a second scenario according to an embodiment.

Referring to FIG. 6, in a second scenario, a UE transmits an uplink sensing signal (e.g., a sounding reference signal (SRS)) and a base station performs sensing.

More specifically, the base station configures an uplink sensing signal in the second carrier frequency (F2) and, in step 601, sends the configuration information to the UE. For example, the base station may send the configuration information in DCI, MAC CEs, or RRC signaling.

In step 602, the UE transmits an uplink sensing signal (i.e., a coarse sensing SRS) and a base station performs sensing. More specifically, the base station measures characteristics of the uplink sensing signal and estimates the coarse location of target objects based on the measurements.

For the 2^{nd} stage, i.e., the fine detection stage, the base station configures an uplink sensing signal to be transmitted in the third carrier frequency (F3) to the candidate region determined in the first stage, and in step 603, sends the configuration information to the UE. For example, the base station may send the configuration information in DCI, MAC CEs, or RRC signaling.

In step 604, the UE transmits the uplink sensing signal (i.e., a fine sensing SRS) in the third carrier frequency (F3) towards the candidate region determined in the 1^{st} stage. Either a single sensing signal transmission or multiple sensing signal transmissions are possible. For example, there may be multiple transmissions in time with different beams (i.e., beam sweeping).

Thereafter, the base station measures characteristics of the sensing signal and refines the estimated location of target objects based on the measurements.

While FIGS. 5 and 6 illustrate examples in which a gNB receives measurements from a UE and then determines locations of target objects and based on the measurements, the disclosure is not limited thereto. For example, after performing the measurements, the UE may determines locations of target objects, and provide information regarding the determined locations of the target objects to the gNB in the sensing reports.

Additionally, although FIGS. 5 and 6 illustrate two scenarios using bi-static sensing between a single UE and a single gNB, the disclosure is not limited thereto. For example, the two-stage operations described above may also be applied to other sensing configurations, e.g., as illustrated in FIG. 1, and with multiple UEs and/or gNBs.

### New Measurement Quantities and Reports for Sensing

To efficiently provided various sensing services, appropriate and accurate measurement results should be provided as feedback, e.g., in the reported measurement results. Accordingly, according to an aspect of the disclosure, one or more types of sensing measurement results and their formats may be defined depending on requirements of different sensing applications at FR1 and FR2. For example, UE sensing measurements and reports at FR1 and FR2 carriers may vary at FR1 and FR2 carriers in order to leverage benefits of both frequency ranges.

Assuming that the majority of UEs will be equipped with antennas operating at both sub-7-GHz frequencies (FR1) and mmWave frequency (FR2), and potentially in other bands (e.g., 10-14 GHz or similar), the presence of such diverse antennas into a single UE will create rich sensing opportunity. For example, sub-7-GHz channel state information (CSI) measurements can provide indication of relatively large motions, can propagate through obstacles (e.g., walls), and contain richer multipath information. However, CSI measurements may be very sensitive to fading and noise, which may lead to inconsistencies in sensing measurements. CSI is also relatively high-dimensional, which often leads to large overhead, as it grows quadratically with the number of subcarriers/sub-bands and antennas.

Received signal strength indicator (RSSI), reference signal received power (RSRP), or reference signal received quality (RSRQ) measurements at mmWave can provide highly-directional information through the usage of beamforming toward a given receiver, but may have a relatively small range due to the presence of blockers (e.g., walls). Moreover, measurements may be more coarse-grained, since the complexity grows with the number of beams.

Given the differences between the two measurements, an aspect of the disclosure is to merge together sensing inputs from sub-7-GHz and mmWave. This may be particularly useful, e.g., for data-driven algorithms, which can work with heterogeneous data concurrently using RSSI and CSI measurements as input to a convolutional neural network (CNN) to classify complex sensing phenomena.

Types of UE measurements for sensing in FR1 or FR2 include:
1. Coarse-grained RSSI/RSRP/RSRQ
   In the unit of dBm, easy to access, coarse channel information
2. Fine-grained CSI at sub-7 GHz
   Complex amplitudes at frequency-domain orthogonal frequency division multiplexing (OFDM) subcarriers (channel frequency response (CFR))
   Truncated channel impulse response (TCIR)
3. Super-grained CSI at FR2 (e.g., 20-60 GHz)
   Complex amplitudes at frequency-domain OFDM subcarriers
   Super-resolution in delay profile (i.e., TCIR) with large overhead (access, storage, processing)
4. Mid-grained (mmWave) beam measurement (e.g., beam signal-to-noise ratios (SNRs)) at FR2
   Data collection and exchange (between a base station and a UE) are already defined in NR standards during beam training (therefore, minimal additional overhead)
   Spatial-domain channel measurements at mmWave bands, weighted by beamforming patterns
5. Fine-grained (mmWave) “image” measurement at FR2, i.e., the map of (range, Doppler) per transmission/reception (Tx/Rx) beam pair or per angle (azimuth, elevation). The (range, Doppler) map may be obtained by pulse Doppler processing of super-grained CSI at FR2.

Depending on the environment or network condition, a gNB can indicate, to a UE, which of the above measurement types/quantities and reports shall be used in FR1 and FR2. For example, this indication can be done via DCI, a MAC CE, or an RRC message. The measurement quantities indication and report indication can be separately indicated or configured by the gNB.

The signaling can be cell-specific, UE-specific, or group-specific (e.g., valid for a pre-defined group of UEs).

For multiple carrier sensing, according to an embodiment, 1) Fine-grained CSI at sub-6 GHz from multiple spatial streams may be combined with 2) Mid-grained beam measurements (e.g., beam SNRs) at the mmWave band of FR2. The details of these two measurements are shown in Table 2 below.

TABLE 2

| | Beam measurement |
|---|---|
| CSI based sensing at FR1 | based sensing at FR2 |
| frequency-domain CFR | spatial-domain link quality over |
| (channel frequency response); | beamforming patterns |
| delay-domain CIR (channel | |
| impulse response) | |
| sensitive to both subtle & | sensitive to only large motions/ |
| large motions | distinct patterns |
| cover large areas | cover small areas |
| (pass through walls) | (blocked by obstacles) |
| richer multipath | sparse propagation paths (with |
| | cluster/group structures) |
| Limited number of antennas with | Phased array with directional |
| omnidirectional beampatterns | beampatterns |
| inconsistent measurements | more repeatable (even in the |
| (channel fading, sensitive to | presence of disturbance) |
| environmental dynamics—pet, | |
| movable home appliances) | |
| high dimension (# subcarriers/ | medium/low dimension |
| subband x # antennas) | (no. of beampatterns) |

Types of CSI based sensing at FR1 include:
CSI full (channel frequency response);
CSI_Amplitude (only amplitude component of CSI);
CSI_Phase (only phase component of CSI); and
(Truncated) time domain power delay profile (PDP).

A delay-domain PDP can be obtained by calculating time domain CIR from CSI through inverse Fourier transform, and reporting the first few complex values (corresponding to the range of interest) of the time domain PDP.

More specifically, for CSI full, the following CSI encoding procedure describes the encoding of the measured CSI, which involves scaling and quantizing the measured CSI, for inclusion in a sensing measurement report. The CSI decoding procedure describes decoding the scaled and quantized CSI that is received in the sensing measurement report.

### Encoding Measured CSI

Measured CSI for a t transmit antenna, an r receive antenna, and k subcarrier/subbands may be represented as a complex value indicated by H(t, r, k). The real part of the CSI is may be indicated by H^{(R)}(t, r, k), and the imaginary part of the CSI may be indicated by H^{(I)}(t, r, k).

Additionally, the encoded CSI may be denoted as Hₑ(t, r, k), the decoded CSI may be denoted as H_{d}(t, r, k), and the numbers of transmit and receive antennas may be indicated by Nₜₓ and Nᵣₓ, respectively.

For a given tuple of transmit and receive antennas, (t, r), the maximum of the absolute value of the real and imaginary parts of the CSI for all subcarriers/subbands may be calculated, which provides an input to obtain a scaling factor as described below. The maximum of the absolute value of the real and imaginary parts of the CSI for all subcarriers may be calculated using Equation (1) below.

$$m ( t , r ) = {max}_{k = \{ 1 , 2 , … , {N}_{SC} \}} \{ max \{ \vert {H}^{( R )} ( t , r , k ) \vert , \vert {H}^{( I )} ( t , r , k ) \vert \} \} \qquad ( 1 )$$

In Equation (1), N_{SC} is the number of subcarriers, and the calculation may be performed for each tuple of transmit and receive antennas, (t, r), t=1, 2, . . . , N_{TX}, r=1, 2, . . . , N_{RX}.

For a given tuple of transmit and receive antennas, a positive scaling factor may be selected to avoid overflow when scaling and quantizing a measured CSI. More specifically, a sensing receiver may selects an exact value of a scaling factor based on Equation (1).

In particular, for a given tuple of transmit and receive antennas, (t, r), the positive scaling factor γ(t, r) is selected to avoid overflow when scaling and quantizing the measured CSI using Equations (2) and (3) below:

$${H}_{e}^{( R )} ( t , r , k ) = round ( \frac{{H}^{( R )} ( t , r , k )}{γ ( t , r )} ) \qquad ( 2 )$$

$${H}_{e}^{( I )} ( t , r , k ) = round ( \frac{{H}^{( I )} ( t , r , k )}{γ ( t , r )} ) \qquad ( 3 )$$

These calculations may be performed for each tuple of transmit and receive antennas, (t, r).

Each real and imaginary part of the CSI may be scaled and quantized to N_{b} bits, and N_{b} may be signaled in the sensing measurement report configuration.

### CSI Decoding

The received encoded CSI can be decoded as described below.

More specifically, the received real and imaginary parts of the scaled and quantized CSI may be decoded as a pair of 2s complement numbers and are combined to form the complex CSI, Hₑ(t, r, k).

Each CSI value may then be rescaled according to Equation 4) below.

$${H}_{d} ( t , r , k ) = γ ( t , r ) {H}_{e} ( t , r , k ) \qquad ( 4 )$$

For reporting at FR2, in addition to reporting an RSRP/SNR of a beam, other information may also be provided.

For example, a range-Doppler-azimuth (R-D-A) map, also known as a sensing image in that it provides an “image” of the surrounding environment, which can be up to a four-dimensional image data including range, Doppler, azimuth, and elevation, can be provided. Also, by combining some or all of the data from the four dimensions, the sensing image can be a two-dimensional, three-dimensional, or up to four-dimensional image.

By detecting an area of higher energy on the R-D-A map, it is possible to identify a location at which there is a reflector or target, and based on this information, subsequent sensing implementation can thus be performed.

Alternatively, a UE can derive target specific parameters from the R-D-A map and then report the target specific parameters such as position, velocity, etc., for each identified target.

In addition, multi-carrier sensing provides a unique opportunity to increase classification accuracy of sensed phenomena, as well as to leverage the increased location-awareness of blockages, e.g., due to humans, animals, objects, etc., to increase the performance of mmWave communication links. For example, understanding the size and movement of blocking entities through sub-7 GHz CSI reports may be used to guide beam selection in the mm Wave link. Similarly, understanding the location of a UE by using sub-7 GHz WiFi sensing can help reduce overhead associated with beam scanning and alignment at mmWave communications.

An existing challenge to the above, is to coordinate time-sensitive multiple carrier sensing operations among multiple UEs in different spectrum bands. Indeed, conversely from the majority of sensing classification tasks, communication-aided sensing will be relatively time-sensitive, with maximum tolerable deadlines in the order of milliseconds. To this end control channels may be introduced into the sub-7 GHz band, which are exclusively dedicated to the coordination of low-latency sensing operations, e.g., F1 as described above. A control channel for carrying sensing control information can be implemented by an enhanced DCI format, an enhanced uplink control information (UCI) format, an enhanced physical sidelink feedback channel (PSFCH) for sidelink, and a MAC CE.

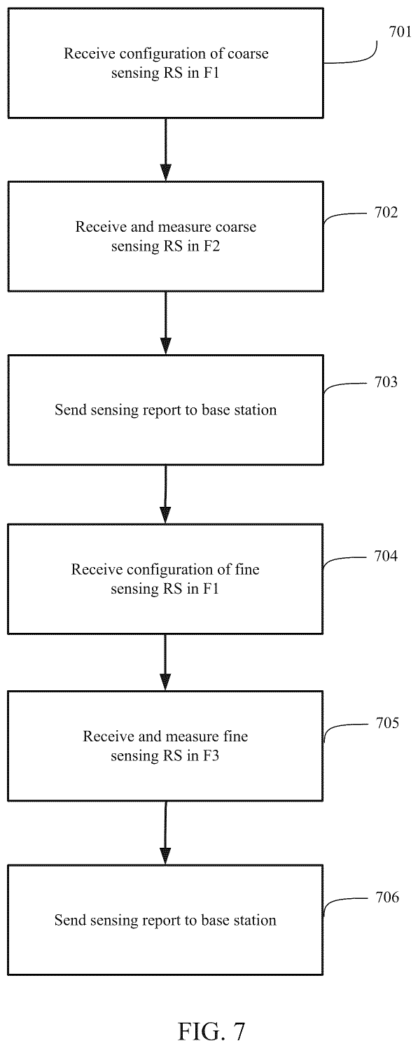

FIG. 7 is a flowchart illustrating a method performed by a UE according to an embodiment. Specifically, FIG. 7 illustrates an example of UE behavior during multiple carrier environment sensing.

Referring to FIG. 7, in step 701, the UE receives, from a base station, in a first (or anchor) carrier frequency (F1), a configuration for a coarse sensing RS, which will be transmitted in a second carrier frequency (F2). Here, F1 can be an FR1 or FR2 carrier, and F2 is an FR1 carrier.

In step 702, the UE receives and measures one or more coarse sensing RSs (e.g., a paging RS PRS or an SRS) on the second carrier frequency (F2). As described above, the measurements of the one or more coarse sensing RSs received from base station to allow for determination of one or more first characteristics (e.g., range, angle, speed, etc.) associated with one or more target objects. The base station can indicate, to the UE, which measurement types/quantities and reports should be used.

In step 703, the UE sends a sensing report to the base station. The sensing report may include measurements of step 702 or an indication of one or more target objects based on the measurement.

In step 704, the UE receives, from the base station, in the first (or anchor) carrier frequency (F1), a configuration for a fine sensing RS, which will be transmitted in a third carrier frequency (F3). Here, F3 is an FR2 carrier.

In step 705, the UE receives and measures one or more fine sensing RSs on the third carrier frequency (F3). More specifically, the UE measures the one or more fine sensing RSs (e.g., a PRS or an SRS) on the third carrier frequency (F3) in FR2, which allows for determination of one or more second characteristics (e.g., range, angle, speed, etc.) associated with the one or more target objects. The accuracy of the one or more second characteristics is higher than an accuracy of the one or more first characteristics.

In step 706, the UE sends a sensing report to the base station. The sensing report may include the measurements of step 705 or a more accurate indication of one or more target objects based on the measurements.

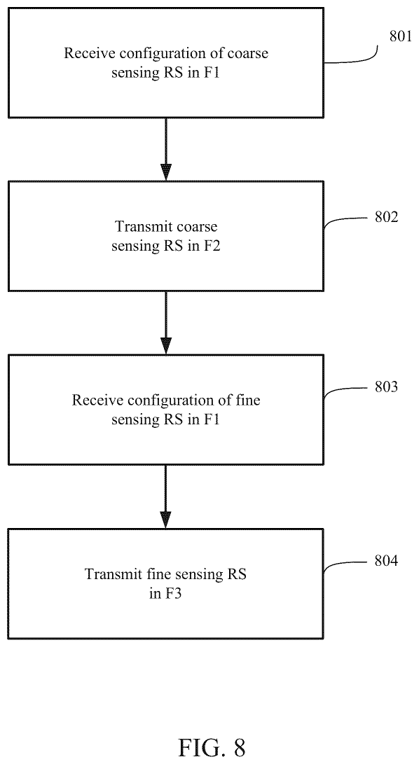

FIG. 8 is a flowchart illustrating a method performed by a UE according to an embodiment. Specifically, FIG. 8 illustrates a UE transmitting an uplink sensing signal (e.g., an SRS) and a base station performs sensing.

Referring to FIG. 8, in step 801, the UE receives, from a base station, in a first (or anchor) carrier frequency (F1), a configuration for a coarse sensing RS, which will be transmitted in a second carrier frequency (F2). For example, the base station may send the configuration information in DCI, MAC CEs, or RRC signaling. Here, F1 can be an FR1 or FR2 carrier, and F2 is an FR1 carrier.

In step 802, the UE transmits one or more coarse sensing RSs on the second carrier frequency (F2) and the base station performs sensing. More specifically, the base station measures characteristics of the one or more coarse sensing RSs and estimates a coarse location of one or more target objects based on the measurements.

In step 803, the UE receives, from the base station, in the first (or anchor) carrier frequency (F1), a configuration for a fine sensing RS, which will be transmitted in a third carrier frequency (F3). Here, F3 is an FR2 carrier.

In step 804, the UE transmits one or more fine sensing RSs on the third carrier frequency (F3), and the base station performs sensing. More specifically, the base station measures the one or more fine sensing RSs on the third carrier frequency (F3) in FR2, and refines the estimated location of the one or more target objects based on the measurements.

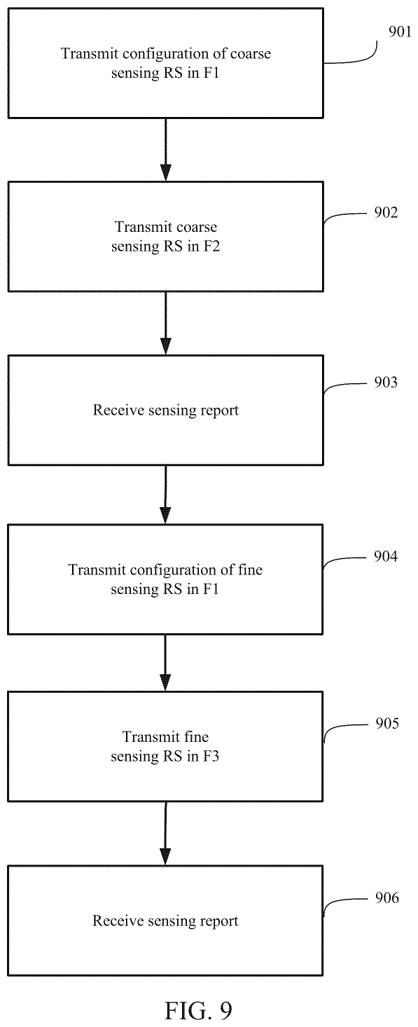

FIG. 9 is a flowchart illustrating a method performed by a base station according to an embodiment. Specifically, FIG. 9 illustrates an example of base station behavior during multiple carrier environment sensing.

Referring to FIG. 9, in step 901, the base station transmits, to a UE, in a first (or anchor) carrier frequency (F1), a configuration for a coarse sensing reference signal (RS), which will be transmitted in a second carrier frequency (F2). Here, F1 can be an FR1 or FR2 carrier, and F2 is an FR1 carrier.

In step 902, the base station transmits, to the UE, one or more coarse sensing RSs (e.g., a paging RS PRS or an SRS) on the second carrier frequency (F2). As described above, the UE measures the one or more coarse sensing RSs received from base station to allow for determination of one or more first characteristics (e.g., range, angle, speed, etc.) associated with one or more target objects. The base station can indicate, to the UE, which measurement types/quantities and reports should be used.

In step 903, the base station receives, from the UE, a sensing report. The sensing report may include the measurements of step 902 or an indication of one or more target objects based on the measurement.

In step 904, the base station transmits, to the UE, in the first (or anchor) carrier frequency (F1), a configuration for a fine sensing RS, which will be transmitted in a third carrier frequency (F3). Here, F3 is an FR2 carrier.

In step 905, the base station transmits one or more fine sensing RSs on the third carrier frequency (F3). More specifically, the UE measures the one or more fine sensing RSs (e.g., a PRS or an SRS) on the third carrier frequency (F3) in FR2, which allows for determination of one or more second characteristics (e.g., range, angle, speed, etc.) associated with the one or more target objects. The accuracy of the one or more second characteristics is higher than an accuracy of the one or more first characteristics.

In step 906, the base station receives a sensing report from the UE. The sensing report may include the measurements of step 905 or a more accurate indication of one or more target objects based on the measurements. When the sensing report includes the measurements of step 905, the base station may determine more accurate location of the one or more target objects based on the measurements.

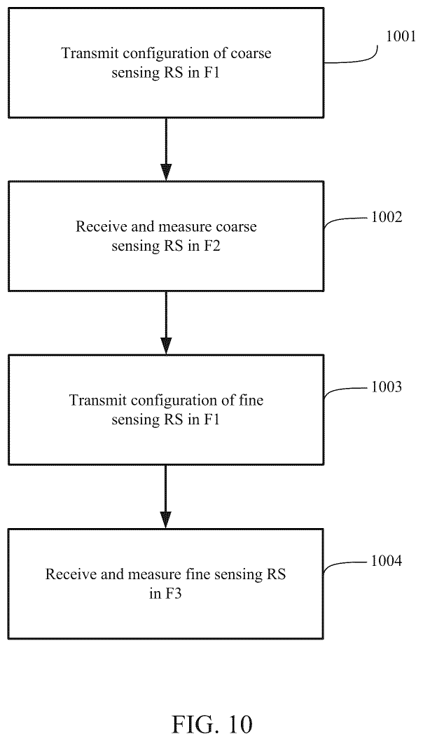

FIG. 10 is a flowchart illustrating a method performed by a base station according to an embodiment. Specifically, FIG. 8 illustrates base station operations in a scenario in which a UE transmits an uplink sensing signal (e.g., an SRS) and the base station performs sensing.

Referring to FIG. 10, in step 1001, the base station transmits, to the UE, in a first (or anchor) carrier frequency (F1), a configuration for a coarse sensing RS, which will be transmitted in a second carrier frequency (F2). For example, the base station may send the configuration information in DCI, MAC CEs, or RRC signaling. Here, F1 can be an FR1 or FR2 carrier, and F2 is an FR1 carrier.

In step 1002, the base station receives and measures, from the UE, one or more coarse sensing RSs on the second carrier frequency (F2) and performs sensing based on the measurements. More specifically, the base station measures characteristics of the one or more coarse sensing RSs and estimates a coarse location of one or more target objects based on the measurements.

In step 1003, the base station transmits, to the UE, in the first (or anchor) carrier frequency (F1), a configuration for a fine sensing RS, which will be transmitted in a third carrier frequency (F3). Here, F3 is an FR2 carrier.

In step 1004, the base station receives and measures, from the UE, one or more fine sensing RSs on the third carrier frequency (F3), and then performs sensing based on the measurements. More specifically, the base station measures the one or more fine sensing RSs on the third carrier frequency (F3) in FR2, and refines the estimated location of the one or more target objects based on the measurements.

The above-described embodiments improve on previous methods because they provide mechanisms with which both FR1 and FR2 carriers may be utilized in a scalable and high accuracy method for ISAC.

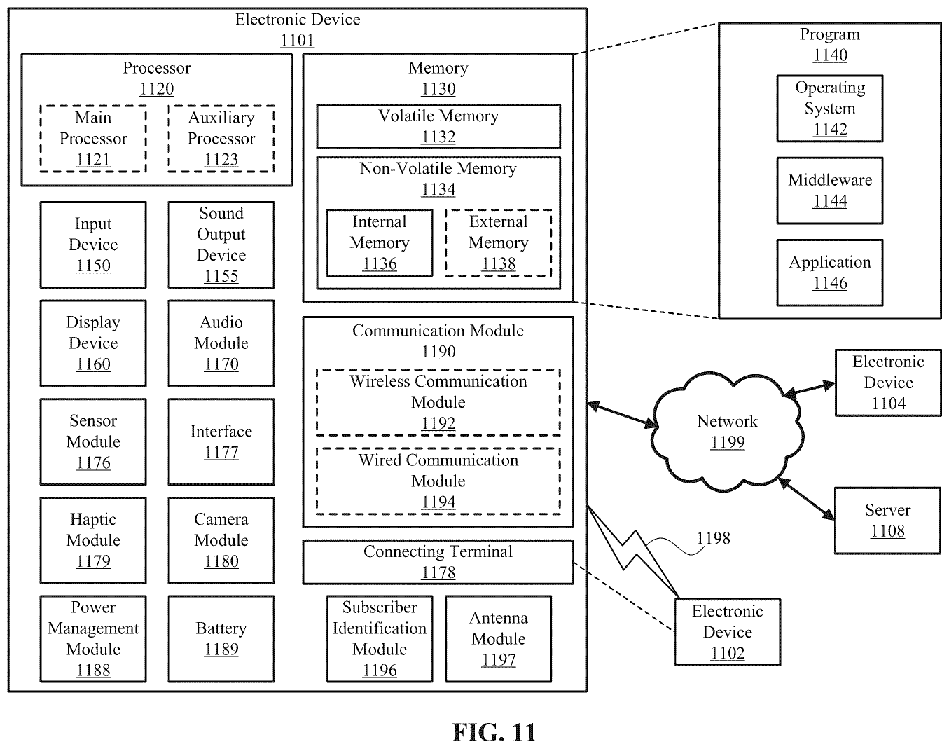

FIG. 11 is a block diagram of an electronic device in a network environment 1100, according to an embodiment.

Referring to FIG. 11, an electronic device 1101 in a network environment 1100 may communicate with an electronic device 1102 via a first network 1198 (e.g., a short-range wireless communication network), or an electronic device 1104 or a server 1108 via a second network 1199 (e.g., a long-range wireless communication network). The electronic device 1101 may communicate with the electronic device 1104 via the server 1108. The electronic device 1101 may include a processor 1120, a memory 1130, an input device 1150, a sound output device 1155, a display device 1160, an audio module 1170, a sensor module 1176, an interface 1177, a haptic module 1179, a camera module 1180, a power management module 1188, a battery 1189, a communication module 1190, a subscriber identification module (SIM) card 1196, or an antenna module 1197. In one embodiment, at least one (e.g., the display device 1160 or the camera module 1180) of the components may be omitted from the electronic device 1101, or one or more other components may be added to the electronic device 1101. Some of the components may be implemented as a single integrated circuit (IC). For example, the sensor module 1176 (e.g., a fingerprint sensor, an iris sensor, or an illuminance sensor) may be embedded in the display device 1160 (e.g., a display).

The processor 1120 may execute software (e.g., a program 1140) to control at least one other component (e.g., a hardware or a software component) of the electronic device 1101 coupled with the processor 1120 and may perform various data processing or computations e.g., the method illustrated in FIG. 7 or 8.

As at least part of the data processing or computations, the processor 1120 may load a command or data received from another component (e.g., the sensor module 1176 or the communication module 1190) in volatile memory 1132, process the command or the data stored in the volatile memory 1132, and store resulting data in non-volatile memory 1134. The processor 1120 may include a main processor 1121 (e.g., a central processing unit (CPU) or an application processor (AP)), and an auxiliary processor 1123 (e.g., a graphics processing unit (GPU), an image signal processor (ISP), a sensor hub processor, or a communication processor (CP)) that is operable independently from, or in conjunction with, the main processor 1121. Additionally or alternatively, the auxiliary processor 1123 may be adapted to consume less power than the main processor 1121, or execute a particular function. The auxiliary processor 1123 may be implemented as being separate from, or a part of, the main processor 1121.

The auxiliary processor 1123 may control at least some of the functions or states related to at least one component (e.g., the display device 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). The auxiliary processor 1123 (e.g., an image signal processor or a communication processor) may be implemented as part of another component (e.g., the camera module 1180 or the communication module 1190) functionally related to the auxiliary processor 1123.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134. Non-volatile memory 1134 may include internal memory 1136 and/or external memory 1138.

The program 1140 may be stored in the memory 1130 as software, and may include, for example, an operating system (OS) 1142, middleware 1144, or an application 1146.

The input device 1150 may receive a command or data to be used by another component (e.g., the processor 1120) of the electronic device 1101, from the outside (e.g., a user) of the electronic device 1101. The input device 1150 may include, for example, a microphone, a mouse, or a keyboard.

The sound output device 1155 may output sound signals to the outside of the electronic device 1101. The sound output device 1155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1160 may visually provide information to the outside (e.g., a user) of the electronic device 1101. The display device 1160 may include, for example, a display, a hologram device, or a projector and control circuitry to control a corresponding one of the display, hologram device, and projector. The display device 1160 may include touch circuitry adapted to detect a touch, or sensor circuitry (e.g., a pressure sensor) adapted to measure the intensity of force incurred by the touch.

The audio module 1170 may convert a sound into an electrical signal and vice versa. The audio module 1170 may obtain the sound via the input device 1150 or output the sound via the sound output device 1155 or a headphone of an external electronic device 1102 directly (e.g., wired) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. The sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device 1102 directly (e.g., wired) or wirelessly. The interface 1177 may include, for example, a high-definition multimedia interface (HDMI), a universal serial bus (USB) interface, a secure digital (SD) card interface, or an audio interface.

A connecting terminal 1178 may include a connector via which the electronic device 1101 may be physically connected with the external electronic device 1102. The connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or an electrical stimulus which may be recognized by a user via tactile sensation or kinesthetic sensation. The haptic module 1179 may include, for example, a motor, a piezoelectric element, or an electrical stimulator.

The camera module 1180 may capture a still image or moving images. The camera module 1180 may include one or more lenses, image sensors, image signal processors, or flashes. The power management module 1188 may manage power supplied to the electronic device 1101. The power management module 1188 may be implemented as at least part of, for example, a power management integrated circuit (PMIC).

The battery 1189 may supply power to at least one component of the electronic device 1101. The battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the AP) and supports a direct (e.g., wired) communication or a wireless communication. The communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as BLUETOOTH™, wireless-fidelity (Wi-Fi) direct, or a standard of the Infrared Data Association (IrDA)) or the second network 1199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The antenna module 1197 may transmit or receive a signal or power to or from the outside (e.g., the external electronic device) of the electronic device 1101. The antenna module 1197 may include one or more antennas, and, therefrom, at least one antenna appropriate for a communication scheme used in the communication network, such as the first network 1198 or the second network 1199, may be selected, for example, by the communication module 1190 (e.g., the wireless communication module 1192). The signal or the power may then be transmitted or received between the communication module 1190 and the external electronic device via the selected at least one antenna.

Commands or data may be transmitted or received between the electronic device 1101 and the external electronic device 1104 via the server 1108 coupled with the second network 1199. Each of the electronic devices 1102 and 1104 may be a device of a same type as, or a different type, from the electronic device 1101. All or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1101. The electronic device 1101 may provide the outcome, with or without further processing of the outcome, as at least part of a reply to the request. To that end, a cloud computing, distributed computing, or client-server computing technology may be used, for example.

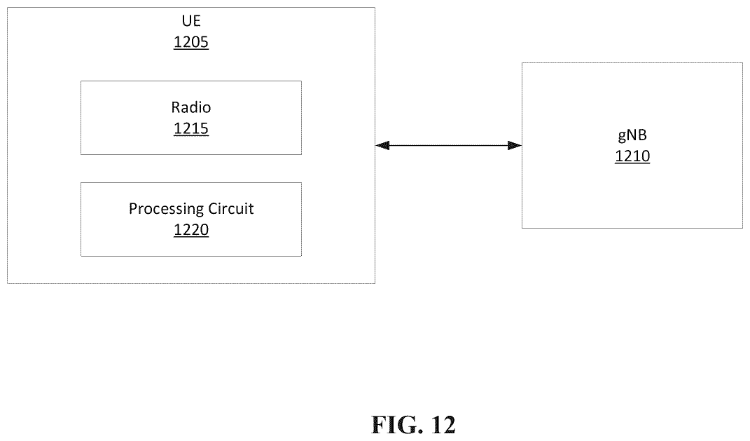

FIG. 12 shows a system including a UE 1205 and a gNB 1210, in communication with each other. The UE may include a radio 1215 and a processing circuit (or a means for processing) 1220, which may perform various methods disclosed herein, e.g., the method illustrated in FIG. 7 or 8. For example, the processing circuit 1220 may receive, via the radio 1215, transmissions from the network node (gNB) 1210, and the processing circuit 1220 may transmit, via the radio 1215, signals to the gNB 1210.

Although not illustrated the gNB 1210 may include a radio and a processing circuit (or a means for processing), which may perform various methods disclosed herein, e.g., the method illustrated in FIG. 9 or 10.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE), the method comprising:
receiving, from a base station, a first reference signal (RS) in a first frequency of a first frequency range;
performing first measurements on the first RS;
transmitting, to the base station, a first sensing report based on the first measurements;
receiving, from the base station, a second RS in a second frequency range of a second frequency range;
performing second measurements on the second RS; and
transmitting, to the base station, a second sensing report based on the second measurements.

2. The method of claim 1, further comprising receiving, from the base station, a first configuration indicating the first frequency of the first frequency range.

3. The method of claim 1, further comprising receiving, from the base station, a second configuration indicating the second frequency of the second frequency range.

4. The method of claim 3, wherein the second configuration is based on the first sensing report.

5. The method of claim 1, wherein the first frequency range is less than 7 GHZ, and the second frequency range is great than 24 GHz.

6. The method of claim 1, wherein the first sensing report includes one of:
full channel state information (CSI) of the first RS;
only an amplitude component of the CSI of the first RS;
only a phase component of the CSI of the first RS; or
a time domain power delay profile of the first RS.

7. The method of claim 1, wherein performing the first measurements on the first RS comprises at least one of:
measuring a coarse receive signal strength of the first RS; or
measuring a fine channel state of the first RS.

8. The method of claim 1, wherein performing the second measurements on the second RS comprises at least one of:
performing a medium beam measurement of the second RS;
measuring a super-fine channel state of the second RS; or
performing a fine grained image measurement of the second RS.

9. The method of claim 1, wherein the first sensing report includes a coarse detection of an object based on the first measurements, and
wherein the second sensing report includes a fine detection of the object based on the second measurements.

10. A user equipment (UE), comprising:
a transceiver; and
a processor configured to:
receive, from a base station, via the transceiver, a first reference signal (RS) in a first frequency of a first frequency range,
perform first measurements on the first RS,
transmit, to the base station, via the transceiver, a first sensing report based on the first measurements,
receive, from the base station, via the transceiver, a second RS in a second frequency range of a second frequency range,
perform second measurements on the second RS, and
transmit, to the base station, via the transceiver, a second sensing report based on the second measurements.

11. The UE of claim 10, wherein the processor is further configured to receive, from the base station, a first configuration indicating the first frequency of the first frequency range.

12. The UE of claim 10, wherein the processor is further configured to receive, from the base station, a second configuration indicating the second frequency of the second frequency range.

13. The UE of claim 12, wherein the second configuration is based on the first sensing report.

14. The UE of claim 10, wherein the first frequency range is less than 7 GHZ, and the second frequency range is great than 24 GHz.

15. The UE of claim 10, wherein the first sensing report includes one of:
full channel state information (CSI) of the first RS;
only an amplitude component of the CSI of the first RS;
only a phase component of the CSI of the first RS; or
a time domain power delay profile of the first RS.

16. The UE of claim 10, wherein the processor is further configured to perform the first measurements on the first RS by performing at least one of:
measuring a coarse receive signal strength of the first RS; or
measuring a fine channel state of the first RS.

17. The UE of claim 10, wherein the processor is further configured to perform the second measurements on the second RS by performing at least one of:
performing a medium beam measurement of the second RS;
measuring a super-fine channel state of the second RS; or
performing a fine grained image measurement of the second RS.

18. The UE of claim 10, wherein the first sensing report includes a coarse detection of an object based on the first measurements, and
wherein the second sensing report includes a fine detection of the object based on the second measurements.

19. A method performed by a base station, the method comprising:
transmitting, to a user equipment (UE), a first reference signal (RS) in a first frequency of a first frequency range;
receiving, from the UE, a first sensing report based on first measurements performed by the UE;
determining a coarse location of an object based on the first sensing report;
transmitting, to the UE, a second RS in a second frequency range of a second frequency range;
receiving, from the UE, a second sensing report based on the second measurements; and
determining a fine location of the object based on the second sensing report.

20. The method of claim 19, further comprising:
transmitting, to the UE, a first configuration indicating the first frequency of the first frequency range; and
transmitting, to the UE, a second configuration indicating the second frequency of the second frequency range,
wherein the second configuration is based on the first sensing report.
